(19) United States
(12) Patent Application Publication
(10) Pub. No.: US 2010/0125479 A1
(43) Pub. Date: May 20, 2010

(54) MEETING SCHEDULER

(75) Inventors: Shanmugasundaram RAVIKUMAR, Berkeley, CA (US); R. Preston McAfee, San Marino, CA (US)

Correspondence Address: YAHOO! INC.;c/o DUANE MORRIS LLP, Attn.: IP Docketing, 30 SOUTH 17TH STREET, Philadelphia, PA, 19103-4196, US

(73) Assignee: YAHOO! INC., Sunnyvale, CA (US)

(21) Appl. No.: 12/271,767

(22) Filed: Nov. 14, 2008

(51) Int. Cl. G06Q 10/00

(52) U.S. Cl. 705/8

(57) ABSTRACT

A method of scheduling meetings includes: providing a first specification for a first set of meetings, wherein the first specification includes for each meeting an attendee list for specifying attendees, a duration for specifying meeting length, and a window for specifying acceptable meeting times; providing a first meeting schedule for the first set of meetings in accordance with the first specification, wherein the first meeting schedule includes a start time and an end time for each meeting; specifying an additional meeting to add to the first set of meetings, whereby a second set of meetings includes the first set of meetings and the additional meeting and a corresponding second specification includes for each meeting an attendee list, a duration, and a window; and determining a second meeting schedule for the second set of meetings by adjusting the first meeting schedule to include the additional meeting in accordance with the second specification.

### BACKGROUND OF THE INVENTION

1. Field of Invention

The present invention relates to scheduling methods generally and more particularly to software directed to scheduling meetings.

2. Description of Related Art

Busy executives often have trouble making time to meet each other. Making a special or important meeting happen may require hours of time by administrative assistants who must examine schedules and test whether or not other meetings can be moved. Thus, there is a need for methods and related systems that enable improved scheduling of meetings.

### SUMMARY OF THE INVENTION

In one embodiment of the present invention, a method of scheduling meetings includes: providing a first specification for a first set of meetings, wherein the first specification includes for each meeting an attendee list for specifying attendees, a duration for specifying meeting length, and a window for specifying acceptable meeting times; providing a first meeting schedule for the first set of meetings in accordance with the first specification, wherein the first meeting schedule includes a start time and an end time for each meeting; specifying an additional meeting to add to the first set of meetings, whereby a second set of meetings includes the first set of meetings and the additional meeting and a corresponding second specification includes for each meeting an attendee list, a duration, and a window; and determining a second meeting schedule for the second set of meetings by adjusting the first meeting schedule to include the additional meeting in accordance with the second specification, wherein the second meeting schedule includes a start time and an end time for each meeting. Determining the second meeting schedule includes: specifying a start time and an end time for the additional meeting, rescheduling one or more start times and end times for meetings in the first set to avoid conflicts with the second specification, and evaluating a rescheduling cost based on one or more rank values of attendees of the one or more rescheduled meetings.

According to one aspect of this embodiment, one or more values for the second specification can be saved in a computer-readable medium. For example, values for the second specification can be saved directly or through some related characterization in memory (e.g., RAM (Random Access Memory)) or permanent storage (e.g., a hard-disk system).

According to another aspect, evaluating the rescheduling cost may include calculating a first-attendee rescheduling cost based on a rank value of a first attendee, wherein the rank value corresponds to a difference in organizational rank between the first attendee and a reference position in a corresponding organization.

According to another aspect, evaluating the rescheduling cost may include calculating a first-attendee rescheduling cost based on a rank value of a first attendee, wherein the rank value corresponds to a reciprocal number of similarly ranked individuals in a corresponding organization.

According to another aspect, determining the second meeting schedule may include: generating candidate schedules for the second set of meetings by permitting successively more rescheduled meetings relative to the first meeting schedule; and comparing rescheduling-cost values for with a threshold value for terminating the generation of candidate schedules.

According to another aspect, the second specification may include an optional-attendee list for at least some meetings, and determining the second meeting schedule may includes: evaluating an optional-attendee rescheduling cost based on one or more rank values of optional attendees for one or more rescheduled meetings with optional attendees; and using values for the optional-attendee rescheduling cost to choose between candidate schedules with similar rescheduling costs.

According to another aspect, the second may specification may include priority values for at least some meetings, and determining the second meeting schedule may include using priority values to weight an arithmetic combination of rescheduling costs in correspondence to priorities of rescheduled meetings.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved scheduling of meetings

### BRIEF DESCRIPTION OF THE DRAWINGS

FIG. 1 shows exemplary structures related to scheduling meetings in accordance with some embodiments of the present invention.

FIG. 2 shows an exemplary organization chart as applied to embodiments of the present invention.

FIG. 3 shows a method for scheduling meetings according to an embodiment of the present invention.

FIG. 4 shows a conventional general-purpose computer.

FIG. 5 shows a conventional Internet network configuration.

### DETAILED DESCRIPTION OF EXEMPLARY EMBODIMENTS

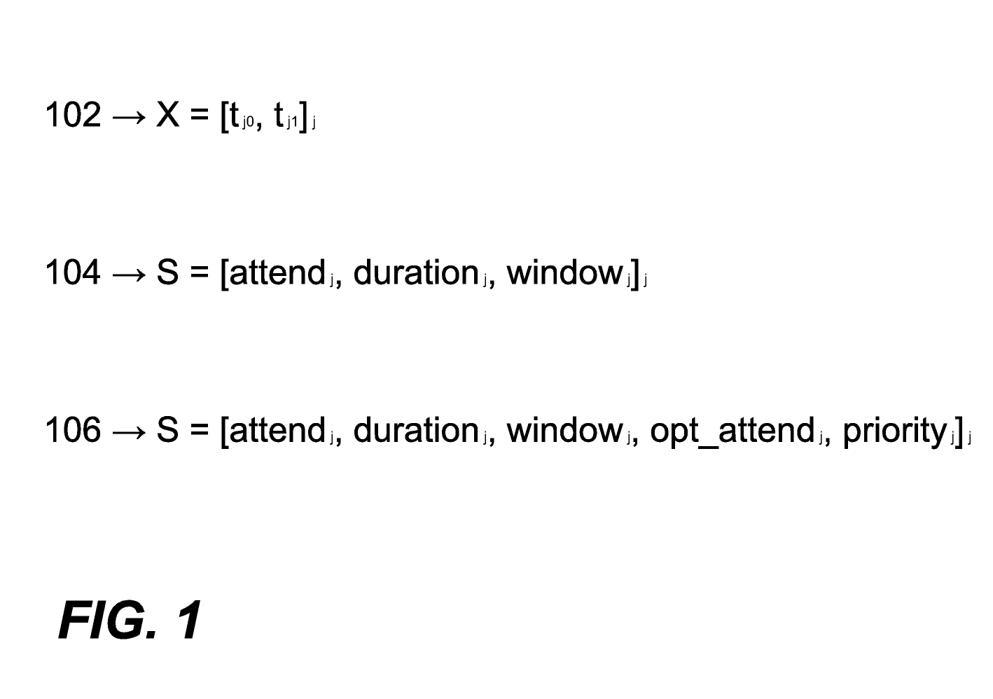

FIG. 1 shows data exemplary structures related to scheduling meetings in accordance with some embodiments of the present invention. A schedule of meetings X 102 is indexed by a meeting index j=1, 2, 3, . . . , n, where n is the total number of meetings in some designated period of time. The j-th meeting has a start time tⱼ₀ and an end time tⱼ₁ (e.g., tⱼ₀=Jun. 1, 2010, 9:00 am ET, tⱼ₁=Jun. 1, 2010, 10:00 am ET). A corresponding Specification for the meetings S 104 is also indexed by j, the meeting index. For each meeting, the specification S includes entries for a list or set of attendees (e.g., attendⱼ={pᵢ}ᵢ includes all attendees for the j-th meeting), a duration for the length of the meeting (e.g., durationⱼ=1 hour), and window of acceptable meeting times (e.g., windowⱼ=“June 1010, Monday-Friday, 9:00 am-5:00 pm”). For example, the schedule X 102 may be considered as an n-x-2 matrix and the specification S 104 may be considered as an n-x-3 matrix.

The specification S 104 provides conditions for an acceptable schedule X 102. For example the schedule X must include all meetings in the specification S and satisfy the conditions for timing (e.g., meeting length (durationⱼ) and acceptable meeting times (windowⱼ)) and attendance (e.g., all attendees (attendⱼ) are included for each meeting and each attendee can only be in one meeting at a given time). Typically the specification S104 and the schedule X 102 are defined in the context of an organization whose membership (e.g., employees) includes the potential attendees and where meeting times are considered over some suitable period (e.g., business hours over a week, month or year).

More elaborate specifications are also possible to include additional requirements, preferences or weighting parameters. For example, the augmented specification S 106 includes additional entries for optional attendees (e.g, opt_attendⱼ={pᵢ}ᵢ includes all optional attendees for the j-th meeting) and priorities (e.g., priorityⱼ=1 on a scale from 1 to 5, where 1 denotes the highest priority). As discussed below, optional attendees can be included in scheduling for informational purposes (e.g, without observing consistency with the specification S) or can be used to discriminate between scheduling options (e.g., as a tie-breaker). Priorities can be used to indicate the acceptability of meeting changes (e.g., as a reluctance to change high-priority meetings or as a weighting factor in evaluating a rescheduling).

In some circumstances a previously scheduled meeting must be rescheduled because its time slot is no longer available (e.g., when an additional meeting has been provisionally scheduled for that time slot). In some embodiments of the present invention, a cost for rescheduling meetings from a schedule X₀ to a schedule X₁ can be expressed as:

Cost(X₀, X₁)=ΣⱼCostⱼ(X₀,X₁) (1)

where the summation j is taken over all individuals in an organization (e.g., potential attendees). In general, one chooses a schedule X₁ that satisfies the corresponding specification S while minimizing (or limiting) the organizational cost Cost(X₀, X₁). The individual cost Costⱼ(X₀, X₁) for some individual pⱼ can be tailored to reflect a corresponding cost or hardship for that individual relative to the priorities of the organization. For example, if there is no change in this individual's schedule in going from X₀ to X₁, then in general Costⱼ(X₀, X₁)=0. Alternatively, if the revised schedule involves a meeting change, this can be considered as a cost to the individual, where the factors may relate to time of day, proximity to other meetings, etc.

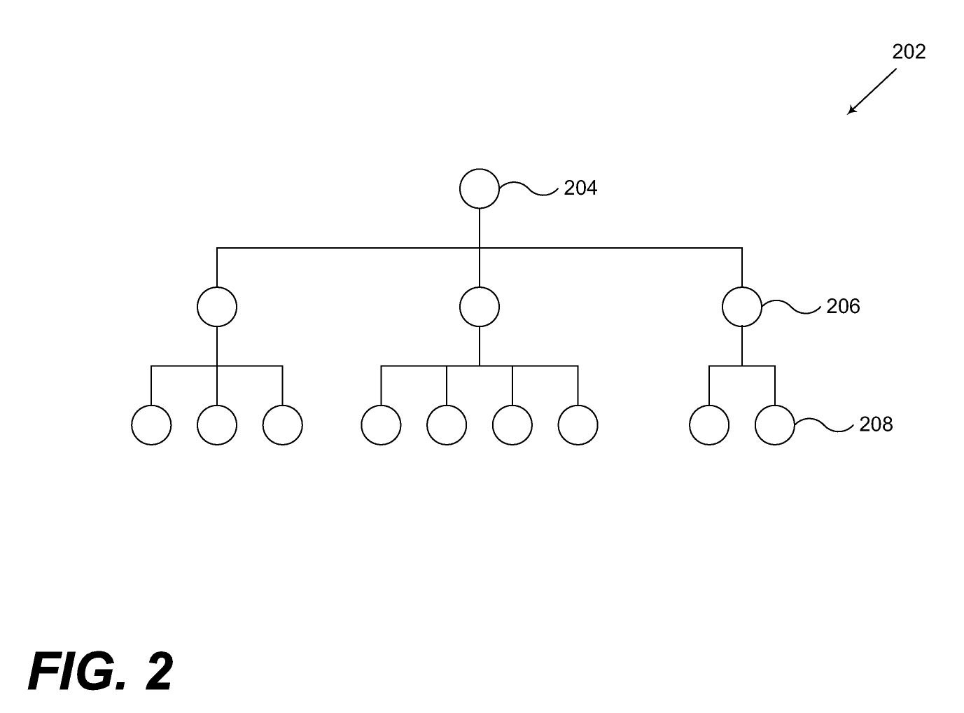

In some case, the cost Costⱼ(X₀, X₁) can be quantified according the rank or position of an individual in a larger organization where the meeting is held. For example, FIG. 2 shows an organizational chart 202, that includes a CEO (Chief Executive Officer) 204 at a first rank, vice presidents at a second rank 206, and directors at a third rank 207. In this context the cost of a meeting change for the j-th individual pⱼ can reflect that individual's rank in the organization, so that highly ranked individuals are less vulnerable to schedule changes. In one embodiment the cost for a schedule change is proportional to the reciprocal of the number of steps to the CEO so that, for example, the rescheduling cost for a vice president 206 is one(1) and the rescheduling cost for a director 208 is one-half (½). By comparison the rescheduling cost for the CEO 204 is infinite although an offset can be used in this formula to avoid this restriction. Alternatively, in another embodiment the cost of a schedule change is proportional to the reciprocal number of individuals at that rank so that for, example, the rescheduling cost for the CEO 204 is one (1), the rescheduling cost for a vice president 206 is one-third(⅓) and the rescheduling cost for a director 208 is one-ninth ( 1/9).

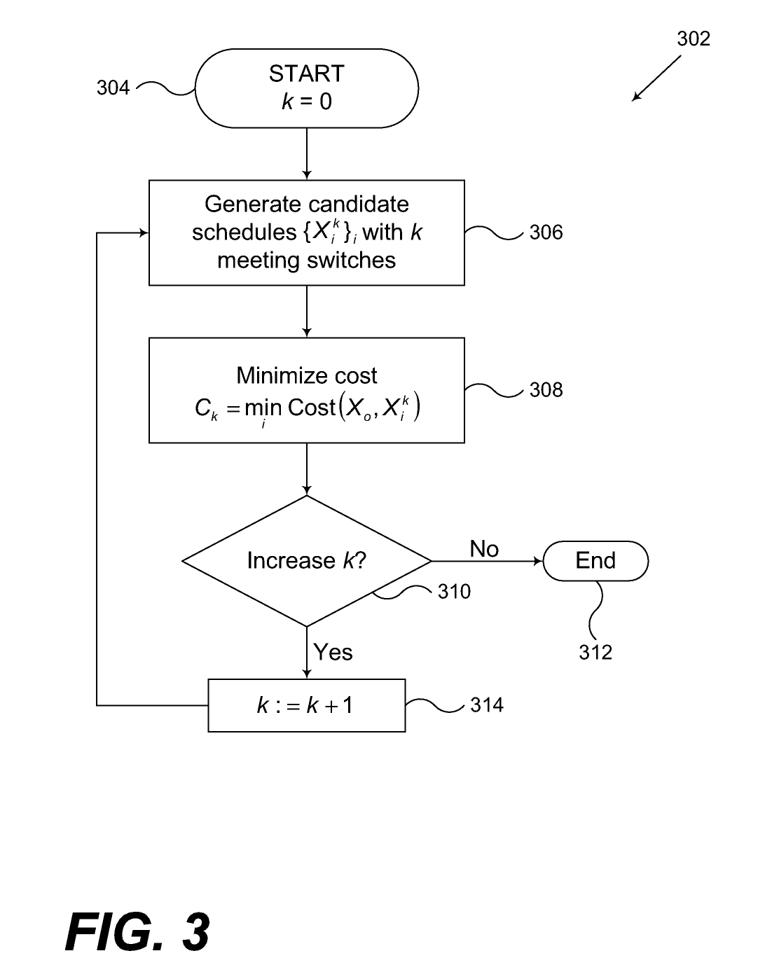

In some embodiments, the optimization goal when adding an additional meeting m₀ to an existing schedule X₀, is to search for candidates schedules Xᵢ that satisfy the corresponding specification S with a minimal number of rescheduled meetings. Among multiple candidate schedules Xᵢ that satisfy the specification S, the minimal cost (e.g, according to Eq. (1)) can be used to select a preferred choice for an updated schedule X₁ that includes that includes the additional meeting m₀. FIG. 3 shows an exemplary method for scheduling meetings according to the present invention. Initially k, the number of rescheduled meeting, is set to zero 304 with the assumption that it is preferable to schedule the additional meeting without disturbing other parts of the schedule.

Next a set of candidate schedule changes {Xᵢ^{k}}ᵢ is generated 306 based on the insertion of the additional meeting m₀ somewhere in the schedule so that (1) the specification conditions for the additional meeting are satisfied and (2) other meetings are rescheduled so that their corresponding specification conditions are satisfied. For example, in the case of k=0, no rescheduled meetings are permitted, and candidate schedules must correspond to scheduling the additional meeting in an unused time slot. In the case of k=1 (one switch), candidate schedules may be generated by considering all possible choices for scheduling the additional meeting that satisfy the specification for the additional meeting (e.g, as to required duration and window) and further considering whether a single meeting can be rescheduled to accommodate this option. Alternatively, a smaller subset of the possible choices for scheduling the additional meeting may be considered according to the requirements of the operational setting. This process can be continued for higher values of k so that, for example, for k=2, candidate schedules would include two rescheduled meetings.

In some embodiments, the generation 306 of candidate schedule changes {Xᵢ^{k}}ᵢ requires that meeting are only rescheduled to time slots that are open in the existing schedule X₀. Note, however, that for k≧2, one can extend the complexity of the schedule generation process 306 by allowing recursions (e.g., where a meeting is provisionally rescheduled into a time slot that is currently occupied by another meeting that must now be rescheduled in order to generate an acceptable candidate schedule).

Next, the cost function is minimized (or reduced to within a threshold) for the candidate schedules 308:

cₖ=minᵢ Cost(X₀, Xᵢ^{k}). (2)

In some cases the generation of candidate schedules Xᵢ^{k} can be combined with the evaluation of the corresponding cost Cost(X₀, Xᵢ^{k}) so that the generation process is terminated when a schedule with a sufficiently low cost has been generated. A decision 310 to increase the number of meeting switches can be made based on the current size of k, the number of candidate schedules already generated, and the cost values for generated candidate schedules. Then, either the process terminates 312 (with a chosen updated schedule X₁) or k is incremented 314 and the process continues with the generation of additional candidate schedules 306.

As noted above, an augmented specification S 106 can be used to include information on optional attendees and meeting priorities. Then, for example, a cost related to optional attendees can be used to choose between schedules that exclude the optional attendees and have similar costs (e.g., the costs with respect to (required) attendees are identical or within a threshold amount). Further, meeting priorities can be used to weight the cost values (e.g., in Eq. (2)) so that changing high-priority meetings results in a higher organizational cost.

At least some values for the results of the method 302 can be output to a user or saved for subsequent use. For example values for the updated schedule X₁ can be saved directly. Alternatively, some derivative or summary form of the results can be saved for later use according to the requirements of the operational setting.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved for later use in a computer-readable medium, including memory (e.g., RAM (Random Access Memory)) and permanent storage (e.g., a hard-disk system).

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

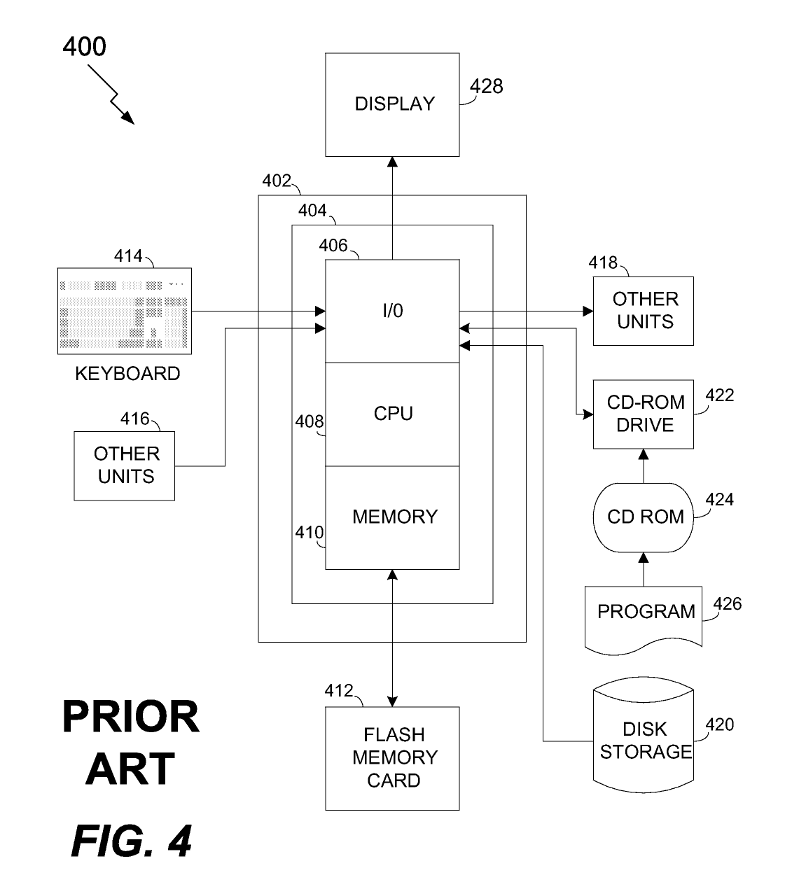

As described above, certain embodiments of the present invention can be implemented using standard computers and networks including the Internet. FIG. 4 shows a conventional general purpose computer 400 with a number of standard components. The main system 402 includes a motherboard 404 having an input/output (I/O) section 406, one or more central processing units (CPU) 408, and a memory section 410, which may have a flash memory card 412 related to it. The I/O section 406 is connected to a display 428, a keyboard 414, other similar general-purpose computer units 416, 418, a disk storage unit 420 and a CD-ROM drive unit 422. The CD-ROM drive unit 422 can read a CD-ROM medium 424 which typically contains programs 426 and other data.

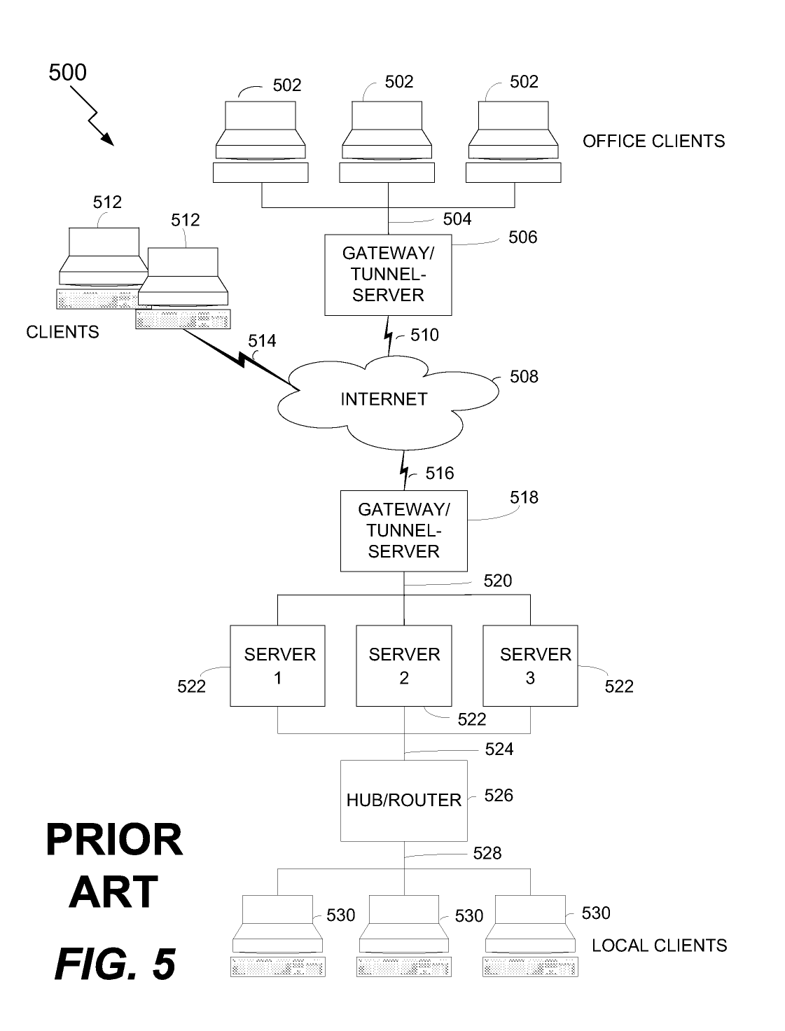

FIG. 5 shows a conventional Internet network configuration 500, where a number of office client machines 502, possibly in a branch office of an enterprise, are shown connected 504 to a gateway/tunnel-server 506 which is itself connected to the Internet 508 via some internet service provider (ISP) connection 510. Also shown are other possible clients 512 similarly connected to the internet 508 via an ISP connection 514. An additional client configuration is shown for local clients 530 (e.g., in a home office). An ISP connection 516 connects the Internet 508 to a gateway/tunnel-server 518 that is connected 520 to various enterprise application servers 522. These servers 522 are connected 524 to a hub/router 526 that is connected 528 to various local clients 530.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of scheduling meetings, comprising:
providing a first specification for a first set of meetings, wherein the first specification includes for each meeting an attendee list for specifying attendees, a duration for specifying meeting length, and a window for specifying acceptable meeting times;
providing a first meeting schedule for the first set of meetings in accordance with the first specification, wherein the first meeting schedule includes a start time and an end time for each meeting;
specifying an additional meeting to add to the first set of meetings, whereby a second set of meetings includes the first set of meetings and the additional meeting and a corresponding second specification includes for each meeting an attendee list, a duration, and a window;
determining a second meeting schedule for the second set of meetings by adjusting the first meeting schedule to include the additional meeting in accordance with the second specification, wherein the second meeting schedule includes a start time and an end time for each meeting and determining the second meeting schedule includes:
specifying a start time and an end time for the additional meeting,
rescheduling one or more start times and end times for meetings in the first set to avoid conflicts with the second specification, and
evaluating a rescheduling cost based on one or more rank values of attendees of the one or more rescheduled meetings; and
saving one or more values for the second meeting schedule in a computer-readable medium.

2. A method according to claim 1, wherein evaluating the rescheduling cost includes calculating a first-attendee rescheduling cost based on a rank value of a first attendee, wherein the rank value corresponds to a difference in organizational rank between the first attendee and a reference position in a corresponding organization.

3. A method according to claim 1, wherein evaluating the rescheduling cost includes calculating a first-attendee rescheduling cost based on a rank value of a first attendee, wherein the rank value corresponds to a reciprocal number of similarly ranked individuals in a corresponding organization.

4. A method according to claim 1, wherein determining the second meeting schedule includes:
generating candidate schedules for the second set of meetings by permitting successively more rescheduled meetings relative to the first meeting schedule; and
comparing rescheduling-cost values for with a threshold value for terminating the generation of candidate schedules.

5. A method according to claim 1, wherein the second specification includes an optional-attendee list for at least some meetings, and determining the second meeting schedule includes:
evaluating an optional-attendee rescheduling cost based on one or more rank values of optional attendees for one or more rescheduled meetings with optional attendees; and
using values for the optional-attendee rescheduling cost to choose between candidate schedules with similar rescheduling costs.

6. A method according to claim 1, wherein the second specification includes priority values for at least some meetings, and determining the second meeting schedule includes using priority values to weight an arithmetic combination of rescheduling costs in correspondence to priorities of rescheduled meetings.

7. An apparatus for scheduling meetings, the apparatus comprising a computer for executing computer instructions, wherein the computer includes computer instructions for:
providing a first specification for a first set of meetings, wherein the first specification includes for each meeting an attendee list for specifying attendees, a duration for specifying meeting length, and a window for specifying acceptable meeting times;
providing a first meeting schedule for the first set of meetings in accordance with the first specification, wherein the first meeting schedule includes a start time and an end time for each meeting;
specifying an additional meeting to add to the first set of meetings, whereby a second set of meetings includes the first set of meetings and the additional meeting and a corresponding second specification includes for each meeting an attendee list, a duration, and a window; and
determining a second meeting schedule for the second set of meetings by adjusting the first meeting schedule to include the additional meeting in accordance with the second specification, wherein the second meeting schedule includes a start time and an end time for each meeting and determining the second meeting schedule includes:
specifying a start time and an end time for the additional meeting,
rescheduling one or more start times and end times for meetings in the first set to avoid conflicts with the second specification, and
evaluating a rescheduling cost based on one or more rank values of attendees of the one or more rescheduled meetings.

8. An apparatus according to claim 7, wherein the computer includes a processor with memory for executing at least some of the computer instructions.

9. An apparatus according to claim 7, wherein the computer includes circuitry for executing at least some of the computer instructions.

10. An apparatus according to claim 7, wherein evaluating the rescheduling cost includes calculating a first-attendee rescheduling cost based on a rank value of a first attendee, wherein the rank value corresponds to a difference in organizational rank between the first attendee and a reference position in a corresponding organization.

11. An apparatus according to claim 7, wherein evaluating the rescheduling cost includes calculating a first-attendee rescheduling cost based on a rank value of a first attendee, wherein the rank value corresponds to a reciprocal number of similarly ranked individuals in a corresponding organization.

12. An apparatus according to claim 7, wherein determining the second meeting schedule includes:
generating candidate schedules for the second set of meetings by permitting successively more rescheduled meetings relative to the first meeting schedule; and
comparing rescheduling-cost values for with a threshold value for terminating the generation of candidate schedules.

13. An apparatus according to claim 7, wherein the second specification includes an optional-attendee list for at least some meetings, and determining the second meeting schedule includes:
evaluating an optional-attendee rescheduling cost based on one or more rank values of optional attendees for one or more rescheduled meetings with optional attendees; and
using values for the optional-attendee rescheduling cost to choose between candidate schedules with similar rescheduling costs.

14. An apparatus according to claim 7, wherein the second specification includes priority values for at least some meetings, and determining the second meeting schedule includes using priority values to weight an arithmetic combination of rescheduling costs in correspondence to priorities of rescheduled meetings.

15. A computer-readable medium that stores a computer program for scheduling meetings, wherein the computer program includes instructions for:
providing a first specification for a first set of meetings, wherein the first specification includes for each meeting an attendee list for specifying attendees, a duration for specifying meeting length, and a window for specifying acceptable meeting times;
providing a first meeting schedule for the first set of meetings in accordance with the first specification, wherein the first meeting schedule includes a start time and an end time for each meeting;
specifying an additional meeting to add to the first set of meetings, whereby a second set of meetings includes the first set of meetings and the additional meeting and a corresponding second specification includes for each meeting an attendee list, a duration, and a window; and
determining a second meeting schedule for the second set of meetings by adjusting the first meeting schedule to include the additional meeting in accordance with the second specification, wherein the second meeting schedule includes a start time and an end time for each meeting and determining the second meeting schedule includes:
specifying a start time and an end time for the additional meeting,
rescheduling one or more start times and end times for meetings in the first set to avoid conflicts with the second specification, and
evaluating a rescheduling cost based on one or more rank values of attendees of the one or more rescheduled meetings.

16. A computer-readable medium according to claim 15, wherein evaluating the rescheduling cost includes calculating a first-attendee rescheduling cost based on a rank value of a first attendee, wherein the rank value corresponds to a difference in organizational rank between the first attendee and a reference position in a corresponding organization.

17. A computer-readable medium according to claim 15, wherein evaluating the rescheduling cost includes calculating a first-attendee rescheduling cost based on a rank value of a first attendee, wherein the rank value corresponds to a reciprocal number of similarly ranked individuals in a corresponding organization.

18. A computer-readable medium according to claim 15, wherein determining the second meeting schedule includes:
generating candidate schedules for the second set of meetings by permitting successively more rescheduled meetings relative to the first meeting schedule; and
comparing rescheduling-cost values for with a threshold value for terminating the generation of candidate schedules.

19. A computer-readable medium according to claim 15, wherein the second specification includes an optional-attendee list for at least some meetings, and determining the second meeting schedule includes:
evaluating an optional-attendee rescheduling cost based on one or more rank values of optional attendees for one or more rescheduled meetings with optional attendees; and
using values for the optional-attendee rescheduling cost to choose between candidate schedules with similar rescheduling costs.

20. A computer-readable medium according to claim 15, wherein the second specification includes priority values for at least some meetings, and determining the second meeting schedule includes using priority values to weight an arithmetic combination of rescheduling costs in correspondence to priorities of rescheduled meetings.
